(19) United States
(12) Patent Application Publication
(10) Pub. No.: US 2023/0172395 A1
(43) Pub. Date: Jun. 8, 2023

(54) CAPSULE HOLDER FOR HOLDING A GAS CAPSULE

(71) Applicant: iSi GmbH, Wien (AT)

(72) Inventors: Andreas HOEFFERER, Wien (AT); Daniel MANOJLOVIC, Wien (AT)

(73) Assignee: iSi GmbH, Wien (AT)

(21) Appl. No.: 17/974,776

(22) Filed: Oct. 27, 2022

(30) Foreign Application Priority Data
Dec. 7, 2021 (EP) 21212933.2

(51) Int. Cl. A47J 43/12; B65D 83/38; B65D 83/66; A23P 30/40

(52) U.S. Cl. CPC A47J 43/128; B65D 83/384; B65D 83/66; A23P 30/40

(57) ABSTRACT

A capsule holder for holding a gas capsule for an apparatus for output of an output medium includes a gas capsule holder element configured as a deep-drawn part having an opening for holding the gas capsule. A cover configured essentially in the manner of a sleeve surrounds the gas capsule holder element from the outside, at least in certain sections. The capsule holder includes a threaded ring configured as a separate element, having an inside thread and/or an outside thread, wherein the threaded ring is firmly connected with the gas capsule holder element and arranged in the region of the opening, so as to make introduction of the gas capsule into the gas capsule holder element possible through the threaded ring.

### CROSS REFERENCE TO RELATED APPLICATIONS

Applicant claims priority under 35 U.S.C. § 119 of European Application No. 21212933.2 filed Dec. 7, 2021, the disclosure of which is incorporated by reference.

### BACKGROUND OF THE INVENTION

### 1. Field of the Invention

The present invention relates to a capsule holder for holding a gas capsule for an apparatus for output of an output medium, as well as to an apparatus having a capsule holder according to the invention.

### 2. Description of the Related Art

AT 411171 B discloses an apparatus for producing, storing, and outputting a food in the form of a cream, situated in a device interior, in particular whipped cream as well as hot foods that are foamed up and are in the form of a sauce, wherein the apparatus is essentially composed of a container having a device interior and a head, which functions as a lid for the container. In this regard, the container is filled, at the beginning, with the food to be sprayed, in each instance, and subsequently closed off using the head. The food or the medium to be sprayed is present, in this regard, in the liquid form in the container or in the device interior. By means of introducing a gas, preferably N₂O or CO₂, from a gas capsule into the device interior, the pressure in the device interior increases in such a manner that the gas particles are dissolved in the food. During removal, i.e. during spraying, the dissolved gas expands. As a result, foaming of the food occurs, i.e. the food is changed to a cream-form state or foam state or sauce state. In this regard, a capsule holder serves for arranging the gas capsule on the apparatus, so as to produce and guarantee a fluidic connection of the gas capsule with the apparatus, wherein the capsule holder has an outside thread for a screw connection with the head.

In this regard, the problem occurs that due to the high pressures in the gas capsule, possible injuries can come about, in particular when screwing the capsule holder on or off, with the gas capsule arranged in it. This risk is especially possible when impermissibly using an incorrect gas capsule at higher pressures (generally from a different manufacturer), wherein potentially destruction of the capsule holder by means of a pressure stress brought about by the gas capsule comes about. In order to prevent such destruction, known capsule holders are configured to be very massive and in one piece, in particular as cast parts, and this configuration is disadvantageously connected with great weight and high costs.

US 2004/217198 A1 discloses a paint spraying system, in which paint is sprayed using a gas cartridge, which results in the advantage that the system is configured to be lighter and smaller, and also easier to handle as compared with conventional floor-mounted devices. In this regard, a cartridge holder serves to hold the gas cartridge, into which holder the gas cartridge is first set and subsequently screwed to the paint spraying system by means of a screw thread, wherein a holder bushing serves for centering the gas cartridge. In detail, the gas cartridge is pierced open when the cartridge holder is screwed on, by means of a piercing tube or a piercing needle that is arranged in the holding socket, and thereby the gas flows out of the gas cartridge into a pressure regulator.

U.S. Pat. No. 2,631,891 A discloses a spraying system for insect extermination agents, wherein the insect extermination agent is sprayed out of a gas capsule by means of compressed air. In this regard, the gas capsule is inserted into a gas capsule holder that is configured in one piece, and subsequently the gas capsule holder is screwed to a connection element that has a cuff for centering and sealing the gas capsule. While being screwed on, the gas capsule is centered by the cuff so that a membrane of the gas capsule is pierced open by a piercing pin.

EP 3 501 630 B1 discloses an apparatus for output of fluids, preferably cooled fluids, wherein when using the apparatus, a gas capsule is set into a gas capsule holder. In this regard, in order to guarantee better handling behavior, the gas capsule holder is surrounded by a gas capsule holder cover configured in the manner of a sleeve, over its mantle surface, at least in certain sections.

### SUMMARY OF THE INVENTION

It is therefore a task of the invention to create a capsule holder by means of which possible movement of a gas capsule out of an apparatus for output of an output medium can be reliably prevented, and the disadvantages mentioned above can be avoided. In particular, the capsule holder should be easy to produce and use little material, so as to protect the environment and to reduce costs, and should preferably be configured so that it can be cleaned in the dishwasher.

In order to accomplish the stated task, a capsule holder in accordance with the invention is provided. In this regard, the capsule holder serves to hold a gas capsule for an apparatus for output of an output medium, in particular a fluid or spray media such as, for example, foods in cream form, in particular whipped cream as well as warm, foamed and sauce-form foods and/or soda water. In this regard, the capsule holder comprises a gas capsule holder element having an opening to hold the gas capsule and a cover configured essentially in the manner of a sleeve, which surrounds or encloses the gas capsule holder element from the outside, at least in certain sections. According to the invention, the capsule holder comprises a threaded ring configured as a separate element, having an inside thread and/or an outside thread, wherein the threaded ring is firmly connected with the gas capsule holder element and arranged in the region of the opening, so as to make introduction of the gas capsule into the gas capsule holder element through the threaded ring possible, and the gas capsule holder element is configured as a deep-drawn part, preferably composed of stainless steel. As a result, the advantage occurs, in contrast to previous capsule holders, which are configured in one piece, in particular as a cast part, that significantly lower wall thicknesses are necessary in certain sections, and thereby a saving in material and thus a saving in weight and costs can be implemented.

In particular, the dimensioning of the threaded ring can take place separately from the dimensioning of the gas capsule holder element.

The threaded ring is an essentially ring-shaped element having an inside and/or outside thread for a screw connection with a head of the apparatus. For a screw connection, a gas capsule connector having a corresponding counter-thread for the threaded ring can be arranged on the head.

Embodiments of the threaded ring with inside thread and outside thread are conceivable, so as to make use with the most varied apparatuses for output of an output medium possible. More precisely, embodiments are conceivable that make use of a screw connection with the most varied heads of apparatuses for output of an output medium.

According to what has been said above, the threaded ring is dimensioned in such a manner that the gas capsule can be introduced into the gas capsule holder element through the threaded ring, i.e. the threaded ring has a correspondingly large clear cross-section. Accordingly, for proper insertion of the gas capsule into the capsule holder, the inside thread of the threaded ring can have a thread diameter or clear diameter that is greater than a gas capsule outside diameter of the gas capsule. If the threaded ring has an outside thread, then a diameter of the clear cross-section is configured to be greater than the gas capsule outside diameter, in any case.

In a preferred embodiment of the capsule holder according to the invention, it is provided that a material-fit and/or shape-fit connection of the gas capsule holder element with the threaded ring is provided. In this way, the requirements regarding safety can be met in this way, in particular by means of the combination of a material-fit connection and a shape-fit connection.

In a particularly preferred embodiment of the capsule holder according to the invention, it is provided that the connection is made in the form of a glue connection and/or a weld connection and/or a deformation, for example in the form of a crimping or by means of rolling, and thereby a material saving and thus a weight saving and a cost saving can be implemented.

In a preferred embodiment of the capsule holder according to the invention, it is provided that the cover comprises an inner surface that faces the gas capsule holder element, and encloses the gas capsule holder element completely from the outside, and thereby a larger gripping surface and also a more appealing outer shape, which can be structured as desired, are guaranteed.

In a preferred embodiment of the capsule holder according to the invention, it is provided that the cover encloses the threaded ring from the outside, at least in certain sections, preferably completely. By means of such a configuration of the cover, the esthetic outer shape can be further improved, and also the handling surface can be further increased, which further improves the handling. Furthermore, it would be conceivable that the threaded ring is not directly connected with the gas capsule holder element, but rather is connected only indirectly, by way of the cover, wherein the cover can be configured to be correspondingly stable.

In a preferred embodiment of the capsule holder according to the invention, it is provided that the gas capsule holder element encloses the threaded ring from the outside, at least in certain sections, preferably completely. In this way, particularly great mechanical stability can be guaranteed.

In a preferred embodiment of the capsule holder according to the invention, it is provided that the threaded ring comprises at least one groove into which the cover and/or the gas capsule holder element engage/engages, wherein this results not only in a simple connection possibility of cover and/or gas capsule holder element with the threaded ring, but also in a material saving and thereby a weight reduction.

In such case, for an easily-produced and stable connection of gas capsule holder element and threaded ring, the gas capsule holder element may have a projection that faces inwardly and is configured using a bead that lies on the outside to engage with the groove of the threaded ring. In this regard, the projection or the bead is arranged on the apparatus on the opening side in the arranged state of the capsule holder, i.e. in the direction of the apparatus.

Alternatively or in addition, it can be provided, in addition to the connection of cover and threaded ring, which is easy to produce and at the same time stable, that the cover comprises a projection that is arranged in the region of the opening of the gas capsule holder element, which projection is in engagement with the groove.

As described previously, the gas capsule holder element may enclose the threaded ring from the outside, at least in certain sections, preferably completely. Alternatively, or in addition, it is possible that the cover surrounds the gas capsule holder element as well as the threaded ring from the outside, at least in certain sections. Once again, embodiments occur that are particularly stable mechanically and, at the same time, allow improved handling as well as a particularly appealing external appearance.

For this purpose, in a particularly preferred embodiment of the capsule holder according to the invention, the threaded ring has a first end, viewed along a longitudinal axis of the capsule holder, that faces the gas capsule holder element, and a formed edge in the region of an opposite second end. The cover is in engagement with, and encloses at least in certain sections, the formed edge. In this regard, the formed edge, into which the cover engages, preferably by means of shape fit, serves as an axial securing means to prevent pull-off, i.e. the forces that occur when the gas capsule is pierced open are absorbed only by the gas capsule holder element including the threaded ring. In this regard, the cover can function merely as a design element and can serve, in particular, to improve the haptics, i.e. the handling when screwing the gas capsule into place.

In a preferred embodiment of the capsule holder according to the invention, it is provided that the cover is produced from silicone or rubber or a plastic, in particular a soft plastic. This material selection guarantees particularly pleasant haptics for the user.

To increase the functional reliability, it is provided, in a preferred embodiment of the capsule holder according to the invention, that the gas capsule holder element comprises an anti-rotation securing means on an outer surface, preferably in the form of a knurling, to prevent rotation relative to the cover. In particular by means of shape fit, a relative rotation between cover and gas capsule holder element can be reliably prevented in this manner.

Outer surface should be understood to mean a surface that faces outward.

Analogously, to increase the functional reliability in a preferred embodiment of the capsule holder according to the invention, it is provided that the threaded ring comprises an anti-rotation securing means on an outer surface, preferably in the form of a knurling, to prevent rotation relative to the cover. In particular by means of shape fit, a relative rotation between cover and threaded ring can be reliably prevented in this manner.

To achieve an anti-rotation securing means particularly efficiently, by a shape fit, preferably over a large area, in a particularly preferred embodiment of the capsule holder according to the invention, the anti-rotation securing means of the gas capsule holder element and/or the anti-rotation securing means of the threaded ring engages with an inner surface of the cover.

This effect is reinforced by the force that exists when screwing the cover on or off, by means of compressing the cover by hand, and for this reason the cover also preferably consists of a soft material such as silicone or rubber. Also, it is usually easier to achieve better haptics with a softer material for the cover, i.e. better handling behavior.

Of course, alternative embodiments are also conceivable; for example, the cover can also be produced from a very hard material, wherein in this case, the inner surface of the cover, which is configured as a sleeve, has a negative shape relative to a configuration, for example a knurling, on the outer surface of the gas capsule holder element. In this regard, of course, possible alternative connection forms of the cover with the gas capsule holder element are also conceivable, for example gluing or a screw connection. Also, it is conceivable that the cover is formed from a material that is capable of shrinking, similar to a shrink hose, and thereby in the case of possible heating of the cover, a firm connection with the gas capsule holder element can be produced. In this regard, it is also conceivable that the cover is applied using the injection-molding method, as an “insert component.”

In a further preferred embodiment, the cover is configured in one piece, and this configuration ensures great stability.

So as to further increase the strength and thereby to achieve an even greater protective effect, according to the invention the gas capsule holder element is configured as a deep-drawn part, preferably composed of stainless steel. In detail, a deep-drawn part has the advantage that based on the cold solidification during the deep-drawing process, thinner wall thicknesses can be implemented, and thereby less material is needed, and as a consequence lower costs occur.

In a preferred embodiment of the capsule holder according to the invention, it is provided that the capsule holder has a cross-section that is essentially circular. Typically, particularly cost-advantageous production can be guaranteed in this way. It should be noted that technically it is, of course, also conceivable that the threaded ring, the gas capsule holder element, and the cover can fundamentally have any desired cross-section, for example a rectangular cross-section.

Analogous to what has been said above, furthermore an apparatus for output of an output medium and/or of fluids and/or of a spray medium is provided with a capsule holder according to the invention, comprising: a container that can be opened and closed by means of a head, which container forms an interior for holding the output medium; a gas capsule connector, which is arranged on the head; an output nozzle, by means of which the output medium can be discharged from the interior of the container when the apparatus is activated, as well as an operating element, preferably in the form of a lever, for activating the apparatus, wherein a replaceable gas capsule, filled with gas, can be placed into the capsule holder, and the capsule holder can be screwed onto the gas capsule connector, so as to produce and guarantee a fluidic connection between the gas capsule and the apparatus.

In other words, it is provided that in a working state of the apparatus, the gas capsule is held in the capsule holder, and a fluidic connection of the gas capsule with the apparatus is guaranteed, in that the gas capsule is pierced open by means of a piercing unit—on the basis of the aforementioned screw connection of the capsule holder with the gas capsule connector—wherein the gas capsule forms a gas storage unit that allows use of the apparatus for output of the output medium, as long as a gas pressure prevailing in the gas capsule is sufficient to switch a pressure limiting piston (as part of a pressure limiting valve) to an open state and/or to keep it in an open state. In this regard, it should be noted that embodiments without a pressure limiting piston are also conceivable, for example a simple kick-back valve. It is also understood that the use of the apparatus for output requires an output medium in the interior or device interior, because otherwise only the gas will be output.

The gas to be used is preferably di-nitrogen oxide (N₂O) or nitrogen (N₂) or carbon dioxide (CO₂) or argon (Ar). Of course, stating a gas must be understood to mean that possible unavoidable or negligible contaminants are included in it. Accordingly, according to the invention, a system comprising an apparatus according to the invention as well as a replaceable gas capsule filled with gas is provided, wherein the gas is di-nitrogen oxide (N₂O) or nitrogen (N₂) or carbon dioxide (CO_{2 bhyg′ q bhyg′ q}) or argon (Ar).

In a preferred embodiment of the system according to the invention, it is provided that in a closed state of the gas capsule, the gas has a pressure of 50 bar to 200 bar, wherein depending on the construction of the gas capsule, higher pressures are also conceivable.

The gas capsule can—but does not have to—be fluidically connected with the apparatus during its intended use, and remain held in the capsule holder. After all of the output medium has been output and the apparatus is completely free of pressure, however, one will remove the gas capsule in practice, at the latest.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a sectional representation of an apparatus having a first embodiment of a capsule holder according to the invention;

FIG. 2 shows an enlarged detail representation of the apparatus from FIG. 1;

FIG. 3A shows a sectional representation of the first embodiment of the capsule holder according to the invention;

FIG. 3B shows a sectional representation according to FIG. 3A, but without a cover;

FIG. 4A shows a sectional representation of a second embodiment of the capsule holder according to the invention;

FIG. 4B shows a sectional representation according to FIG. 4A, but without a cover;

FIG. 4C shows a side view relating to FIG. 4B;

FIG. 5A shows a sectional representation of a third embodiment of the capsule holder according to the invention;

FIG. 5B shows a sectional representation according to FIG. 5A, but without a cover;

FIG. 6A shows a sectional representation of a fourth embodiment of the capsule holder according to the invention; and

FIG. 6B shows a sectional representation according to FIG. 6A, but without a cover.

### DETAILED DESCRIPTION OF PREFERRED EMBODIMENTS

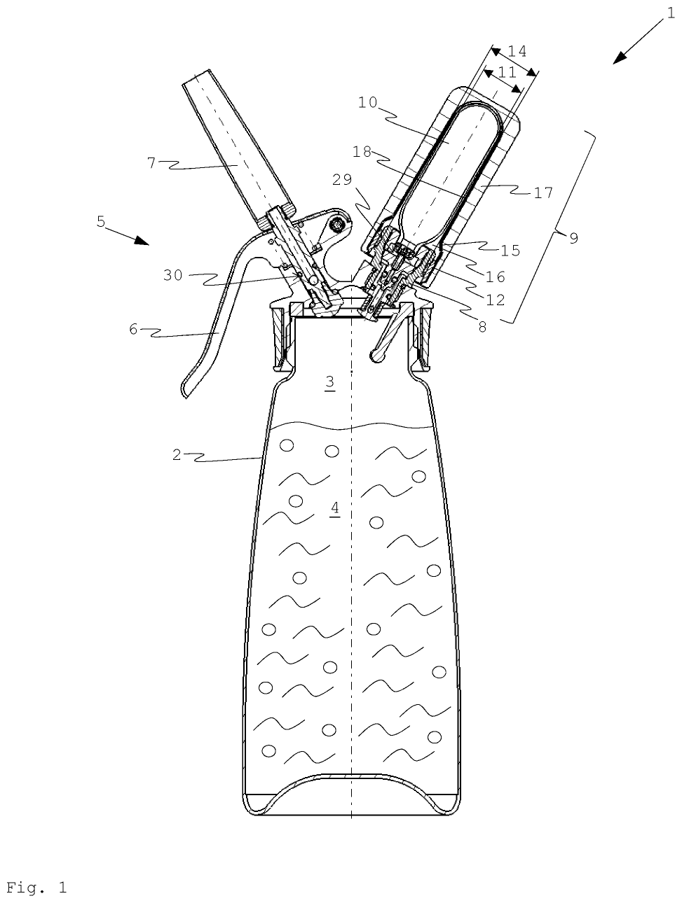

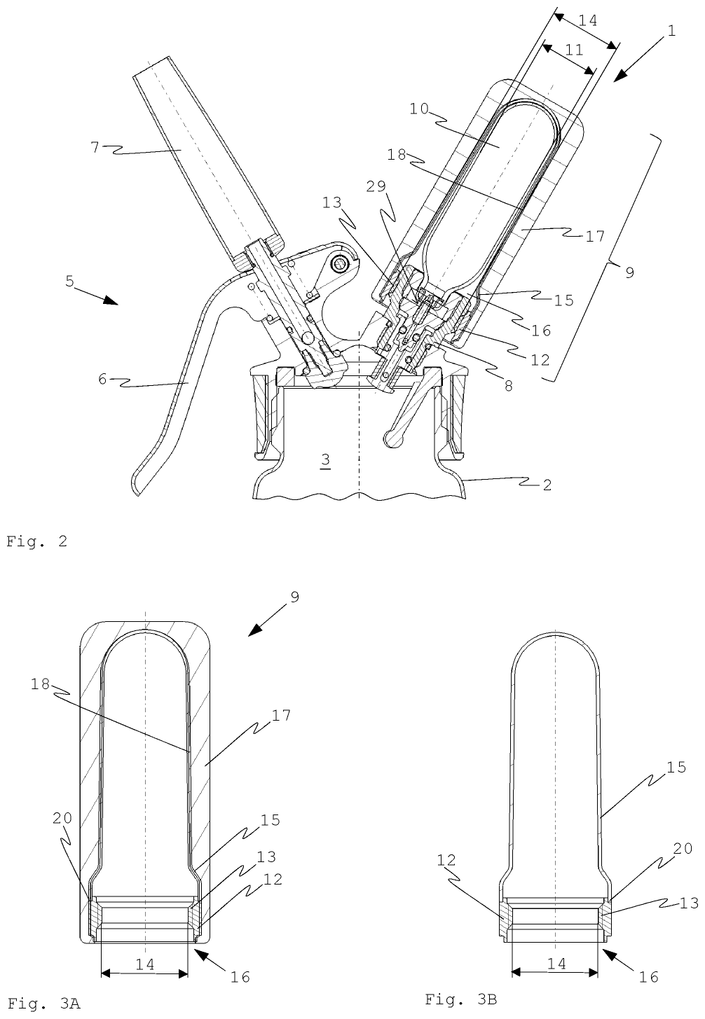

FIG. 1 and FIG. 2 show a sectional representation of an apparatus 1 for output of an output medium 4 or fluid or spray medium, with a first embodiment of a capsule holder 9 according to the invention. The apparatus 1 comprises a container 2, which forms an interior 3 for holding the output medium 4, a head 5 for closing the container 2, the capsule holder 9 for holding a gas capsule 10, an operating element 6, which is preferably configured in the form of a lever or of a pushbutton, as well as an output nozzle 7.

Furthermore, such apparatuses comprise or the apparatus 1 comprises a piercing unit 29 for the gas capsule 10 for proper functioning, so as to pierce a membrane of the gas capsule 10 open when the gas capsule 10 is arranged in the capsule holder 9 and the capsule holder 9 is screwed into the head 5, more precisely into a gas capsule connector 8 arranged on the head 5, so as to produce and guarantee a fluidic connection between the gas capsule 10 and the apparatus 1. Furthermore, such apparatuses comprise or the apparatus 1 comprises a removal system (removal valve 30) for proper functioning, for controlled output.

In this regard, the capsule holder 9 has a threaded ring 12 with which the capsule holder 9 can be screwed onto the gas capsule connector 8, wherein the threaded ring 12 has an inside thread 13 for this purpose, in the exemplary embodiment shown, the (clear) thread diameter 14 of which is greater than a gas capsule outside diameter 11, and thereby the gas capsule 10 can be inserted into the capsule holder 9 through the threaded ring 12. In detail, the gas capsule 10 can be inserted into a gas capsule holder element 15 of the capsule holder 9, wherein for easier and better handling, the gas capsule holder element 15 is surrounded by a cover 17, at least in part. In this regard, the gas capsule holder element 15 contacts an inner surface 18 of the cover 17.

FIG. 3A and FIG. 3B each show a detailed sectional representation of the first embodiment of the capsule holder 9 according to the invention, wherein the cover 17 surrounds the gas capsule holder element 15 and also the threaded ring 12 completely from the outside. In this regard, FIG. 3B does not show a cover 17, for a better understanding. In detail, the gas capsule holder element 15 is inserted into the cover 17 and has an opening 16 for holding or introducing the gas capsule 10. The threaded ring 12 is arranged in the region of the opening 16 of the gas capsule holder element 15, wherein the ring is firmly connected with the gas capsule holder element 15 in a connection region 20, by means of shape fit and/or material fit. For example, the connection can be implemented by means of gluing, welding or the like.

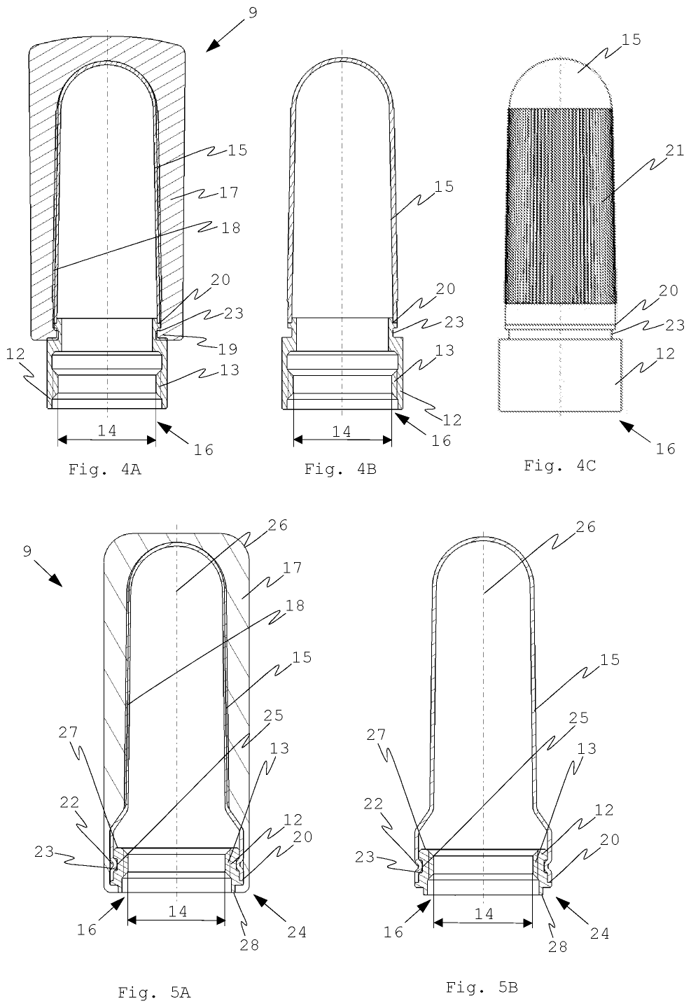

FIG. 4A and FIG. 4B (without cover 17) show a sectional representation of a second embodiment of the capsule holder 9 according to the invention, wherein the cover 17 surrounds the gas capsule holder element 15 completely and the threaded ring 12 only partially. In this regard, the cover 17 has a projection 19, which engages into a groove 23 of the threaded ring 12, wherein the groove 23 is arranged opposite the opening 16, on the side of the capsule holder end, so that at least a partial region of the threaded ring 12 is not enclosed by the cover 17.

FIG. 4C shows, in a side view, the gas capsule holder element 15, wherein an anti-rotation securing means 21 in the form of a knurling is provided on an outer surface of the gas capsule holder element 15. In this regard, the anti-rotation securing means 21 of the gas capsule holder element 15 can stand in engagement with the inner surface 18 of the cover 17, which is configured in the manner of a sleeve, in particular when using the capsule holder 9.

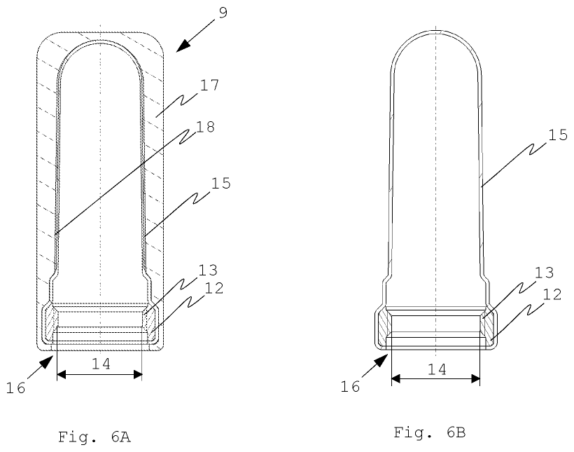

FIG. 5A and FIG. 5B (without cover 17) show a sectional representation of a third embodiment of the capsule holder 9 according to the invention, wherein the threaded ring 12 likewise has the groove 23, which, however, is arranged approximately in the center of the threaded ring 12, and into which groove 23 a projection 25 of the gas capsule holder element 15 that faces inward engages. In this regard, the projection 25 that faces inward is formed by a bead 22 of the gas capsule holder element 15 that lies on the outside. In this regard, it is additionally provided that the gas capsule holder element 15 is connected with the threaded ring 12 in the connection region 20, wherein the connection according to the above explanations can be implemented by means of gluing, welding or the like.

In addition, it is possible, according to FIG. 5A, that the threaded ring 12 comprises a formed edge 24 that is arranged in the region of a second end 28 of the threaded ring 12, wherein the threaded ring has a first end 27, viewed along a longitudinal axis 26 of the capsule holder, which end faces the gas capsule holder element 15, as well as the opposite second end 28. The cover 17 is in engagement with the formed edge 24 of the threaded ring 12 and encloses the formed edge 24 at least in certain sections.

FIG. 6A and FIG. 6B (without cover 17) show a sectional representation of a fourth embodiment of the capsule holder 9 according to the invention, wherein the inner surface 18 completely encloses the cover 17 of the gas capsule holder element 15 from the outside, and the gas capsule holder element 15 in turn completely encloses the threaded ring 12 from the outside.

Although only a few embodiments of the present invention have been shown and described, it is to be understood that many changes and modifications may be made thereunto without departing from the spirit and scope of the invention.

What is claimed is:

1. A capsule holder for holding a gas capsule for an apparatus for output of an output medium, the capsule holder comprising:
(a) a gas capsule holder element configured as a deep-drawn part having an opening for holding the gas capsule;
(b) a sleeve-shaped cover exteriorly surrounding at least certain sections of the gas capsule holder element; and
(c) a threaded ring configured as a separate element from the gas capsule holder element and comprising at least one of an inside thread and an outside thread;
wherein the threaded ring is connected with the gas capsule holder element and arranged near the opening so as to permit introduction of the gas capsule into the gas capsule holder element through the threaded ring.

2. The capsule holder according to claim 1, wherein the gas capsule holder element is connected with the threaded ring with at least one of a material-fit connection and a shape-fit connection.

3. The capsule holder according to claim 1, wherein the gas capsule holder element is connected with the threaded ring with at least one of a glue connection, a weld connection, and a deformation connection.

4. The capsule holder according to claim 1, wherein the cover comprises an inner surface that faces the gas capsule holder element and exteriorly encloses the gas capsule holder element completely.

5. The capsule holder according to claim 1, wherein the cover exteriorly encloses at least certain sections of the threaded ring.

6. The capsule holder according to claim 1,
wherein the threaded ring comprises at least one groove; and
wherein at least one of the cover and the gas capsule holder element engages into the at least one groove.

7. The capsule holder according to claim 6,
wherein the gas capsule holder element has a projection that faces inwardly and is formed by an exterior bead; and
wherein the projection is in engagement with the at least one groove of the threaded ring.

8. The capsule holder according to claim 6,
wherein the cover comprises a projection arranged near the opening of the gas capsule holder element; and
wherein the projection is in engagement with the at least one groove of the threaded ring.

9. The capsule holder according to claim 1, wherein the gas capsule holder element exteriorly encloses at least certain sections of the threaded ring.

10. The capsule holder according to claim 1,
wherein the cover exteriorly surrounds at least certain sections of the threaded ring;
wherein the threaded ring has a first end, seen along a longitudinal axis of the capsule holder, and a second end opposite the first end;
wherein the first end faces the gas capsule holder element;
wherein the threaded ring has a formed edge near the second end; and
wherein the cover is in engagement with the formed edge and encloses at least certain sections of the formed edge.

11. The capsule holder according to claim 1, wherein the gas capsule holder element comprises a gas capsule holder element anti-rotation securing device on an outer surface of the gas capsule holder element to prevent rotation of the gas capsule holder element relative to the cover.

12. The capsule holder according to claim 11, wherein the threaded ring comprises a threaded ring anti-rotation securing device on an outer surface of the threaded ring to prevent rotation of the threaded ring relative to the cover.

13. The capsule holder according to claim 12, wherein at least one of the gas capsule holder element anti-rotation securing device and the threaded ring anti-rotation securing device is in engagement with an inner surface of the cover.

14. The capsule holder according to claim 1, wherein the gas capsule holder element is made of stainless steel.

15. The capsule holder according to claim 5, wherein the cover completely encloses the threaded ring exteriorly.

16. The capsule holder according to claim 9, wherein the gas capsule holder element completely encloses the threaded ring exteriorly.

17. The capsule holder according to claim 1, wherein the gas capsule holder element comprises a knurling on an outer surface of the gas capsule holder element to prevent rotation of the gas capsule holder element relative to the cover.

18. The capsule holder according to claim 1, wherein the threaded ring comprises a knurling on an outer surface of the threaded ring to prevent rotation of the threaded ring relative to the cover.

19. An apparatus for output of an output medium comprising:
the capsule holder according to claim 1;
a container having a head for opening and closing the container, wherein the container forms an interior to hold the output medium;
a gas capsule connector arranged on the head;
an output nozzle configured to enable the output medium to be output from the interior of the container through the output nozzle when the apparatus is activated; and
an operating element for activating the apparatus;
wherein the capsule holder is configured to receive a replaceable gas capsule, filled with gas, and the capsule holder is configured to be screwed onto the gas capsule connector, so as to produce and guarantee a fluidic connection between the gas capsule and the apparatus.

20. The apparatus according to claim 19, wherein the operating element is a lever.

21. A system comprising:
the apparatus according to claim 19; and
a replaceable gas capsule filled with gas;
wherein the gas is di-nitrogen oxide (N₂O) or nitrogen (N₂) or carbon dioxide (CO₂) or argon (Ar).
